(19) United States
(12) Patent Application Publication
(10) Pub. No.: US 2005/0168615 A1
(43) Pub. Date: Aug. 4, 2005

(54) Camera with slide barrier

(76) Inventors: Masahiko Sakimoto, Osaka (JP); Satoshi Yokota, Osaka (JP)

Correspondence Address: BRINKS HOFER GILSON & LIONE, P.O. BOX 10395, CHICAGO, IL, 60610, US

(21) Appl. No.: 10/886,960

(22) Filed: Jul. 8, 2004

(30) Foreign Application Priority Data
Feb. 2, 2004 (JP) 2004-025044

(51) Int. Cl. H04N 5/225

(52) U.S. Cl. 348/335

(57) ABSTRACT

To provide a camera with a slide barrier that achieves reduced activation time. The camera is composed of a slide barrier which is slidable along between a close position to cover a taking lens and an open position to retreat from the taking lens, a detection switch for detecting that the slide barrier is positioned in between the close position and the open position, and a controller for activating the camera when it is detected by the detection switch that the slide barrier is positioned in between the close position and the open position.

### RELATED APPLICATION

This application is based on Japanese Patent Application No. 2004-25044, the content of which is incorporated herein by reference.

### BACKGROUND OF THE INVENTION

The present invention relates to a camera with a slide barrier which is slidable along between an open position and a close position and covers a taking lens at the close position for protection.

Conventionally, there have known a camera with a slide barrier which is slidable along between a close position and an open position and covers a taking lens at the close position for protection. In such a camera, it is often the case that the power is turned on and then the camera is started to be activated at the time when the slide barrier has finished sliding movement from the close position to the open position. Notably in a type of camera whose barrel section, including a taking lens, is extended to an image capturing standby position that is protruded from a body of the camera, it is typical that the barrel section is extended and the camera is put into an activated state when the slide barrier is fully opened in order to prevent interference between the slide barrier and the barrel section.

However, in a type of camera whose barrel section, including a taking lens, does not protrude from the body of the camera, the interference between the slide barrier and the barrel section would not occur. If activation of the camera is nevertheless suspended until the slide barrier finishes moving from the close position to the open position, then a period of time taken for the slide barrier to move to the full open position is to be included in the activation time of the camera.

Moreover, particularly in these days, reducing activation time of the camera is being drawing attention.

### SUMMARY OF THE INVENTION

Accordingly, an object of the present invention is to provide a camera which is activated immediately after the slide barrier is started to be slid from the close position to the open position so as to achieve reduced activation time.

In order to accomplish the above-stated object, a camera in a first aspect of the present invention comprises a slide barrier which is slidable along between a close position to cover a taking lens and an open position to retreat from the taking lens,
a first detection member for detecting that the slide barrier is positioned in between the close position and the open position; and
a controller for activating the camera when it is detected by the first detection member that the slide barrier is positioned in between the close position and the open position.

In the camera in the first aspect of the present invention, the controller may be constructed from a CPU, the camera may further comprise an image pickup device for obtaining an image of an object and a display section for displaying an obtained image, and
the activating the camera may include activating, among the CPU, the image pickup device and the display section, at least the CPU.

The camera in the first aspect of the present invention may further comprise an instruction member for instructing start of modes other than an image capturing mode, wherein the image capturing mode may be executed by the controller when execution of a mode other than the image capturing mode is instructed by the instruction member and then it is detected by the first detection member that the slide barrier is positioned in between the close position and the open position.

The camera in the first aspect of the present invention may further comprise a barrel section including the taking lens, wherein the barrel section may not protrude from a body of the camera during image capturing.

Further in the camera in the first aspect of the present invention, the first detection member may be to detect that the slide barrier is in the vicinity of the close position.

The camera in the first aspect of the present invention may further comprise a second detection member for detecting that the slide barrier is in the open position.

Further in the camera in the first aspect of the present invention, the controller may permit start of image capturing operation when it is detected by the second detection member that the slide barrier is in the open position.

Further in the camera in the first aspect of the present invention, the controller may prohibit start of image capturing operation when it is not detected by the second detection member that the slide barrier is in the open position.

Further in the camera in the first aspect of the present invention, the first detection member and the second detection member may be constructed from one detection member.

Further in the camera in the first aspect of the present invention, the controller may turn the power of the camera off when it is detected by the second detection member that the slide barrier is in the open position and then it is detected by the first detection member that the slide barrier is in the vicinity of the close position.

A camera in a second aspect of the present invention comprises,
a slide barrier which is slidable along between a close position to cover a taking lens and an open position to retreat from the taking lens,
a detection member for detecting that the slide barrier is in the close position; and
a controller for activating the camera when the detection member is in an inactive state.

In the camera in the second aspect of the present invention, the controller may be constructed from a CPU, the camera may further comprise an image pickup device for obtaining an image of an object and a display section for displaying an obtained image, and
the activating the camera may include activating, among the CPU, the image pickup device and the display section, at least the CPU.

Further in the camera in the second aspect of the present invention, the controller may turn the power of the camera off when the detection member turns to be active after being in the inactive state.

The camera in the second aspect of the present invention may further comprise a barrel section including the taking lens, wherein the barrel section may not protrude from a body of the camera during image capturing.

A method for activating a camera with a slide barrier which is slidable along between a close position to cover a taking lens and an open position to retreat from the taking lens comprises the steps of,
detecting that the slide barrier is positioned in between the close position and the open position; and
activating the camera when it is detected that the slide barrier is positioned in between the close position and the open position.

In the method of the present invention, the activating the camera may include activating, among a CPU for controlling the camera, an image pickup device for obtaining an image of an object and a display section for displaying an obtained image, at least the CPU.

Further in the method of the present invention, start of image capturing operation may be permitted when it is detected that the slide barrier is in the open position.

Further in the method of the present invention, start of image capturing operation may be prohibited when it is not detected that the slide barrier is in the open position.

Further in the method of the present invention, the power of the camera is turned off when it is detected that the slide barrier is in the open position and then it is detected that the slide barrier is in the vicinity of the close position.

According to the camera in the first aspect of the present invention as well as the method of the present invention, once it is detected that the slide barrier is positioned in between the close position and the open position (in the vicinity of the close position in particular), the camera is immediately activated, allowing reduction of activating time compared to the case of activating the camera after the slide barrier reaches the open position.

Further in the camera in the second aspect of the present invention, it becomes possible to turn the power off only when the camera is once activated and then the slide barrier is detected to be in the close position by the detection member. This indicates that the power is not turned off if the slide barrier is fully moved to the open position and then moved for a short distance toward the close position side. In some conventional cameras with a slide barrier, even when the slide barrier is improperly moved for a short distance from the open position toward the close position side, the power is turned off and so re-activating operation is required. However, the camera in the second aspect of the present invention is free from this inconvenience, making it possible to avoid complicated procedures for re-activating operation and time loss caused thereby.

### BRIEF DESCRIPTION OF THE DRAWINGS

The present invention will be further described with reference to the accompanying drawings wherein like reference numerals refer to like parts in the several views, and wherein:

FIG. 1A is a front view showing a camera in a first embodiment;

FIG. 1B is a front view showing the camera with an outer slide barrier being in an open position;

FIG. 1C is a rear view showing the camera;

FIG. 2A is a view showing a bending optical system viewed from the top surface of the camera;

FIG. 2B is a view showing the bending optical system viewed from the front surface of the camera;

FIG. 3A is a view showing the internal structure of the outer slide barrier in a close position;

FIG. 3B is a view showing the internal structure of the outer slide barrier in a middle position;

FIG. 3C is a view showing the internal structure of the outer slide barrier in an open position;

FIG. 4 is a block diagram of the camera;

FIG. 5 is a control flow chart;

FIG. 6A is a perspective view showing a camera in a second embodiment viewed from the front surface side of the camera;

FIG. 6B is a perspective view showing the camera with an outer slide barrier in an open position viewed from the front surface side of the camera;

FIG. 7A is a top view showing the camera with the outer slide barrier in a close position;

FIG. 7B is a top view showing the camera with the outer slide barrier in an open position;

FIG. 7C is a front view showing the camera;

FIGS. 8A-8C are views showing the relation between an outer slide barrier and a detection switch;

FIGS. 9A-9C are views showing a detection switch switched in three steps; and

FIG. 10 is a control flow chart.

### DETAILED DESCRIPTION OF THE PREFERRED EMBODIMENTS

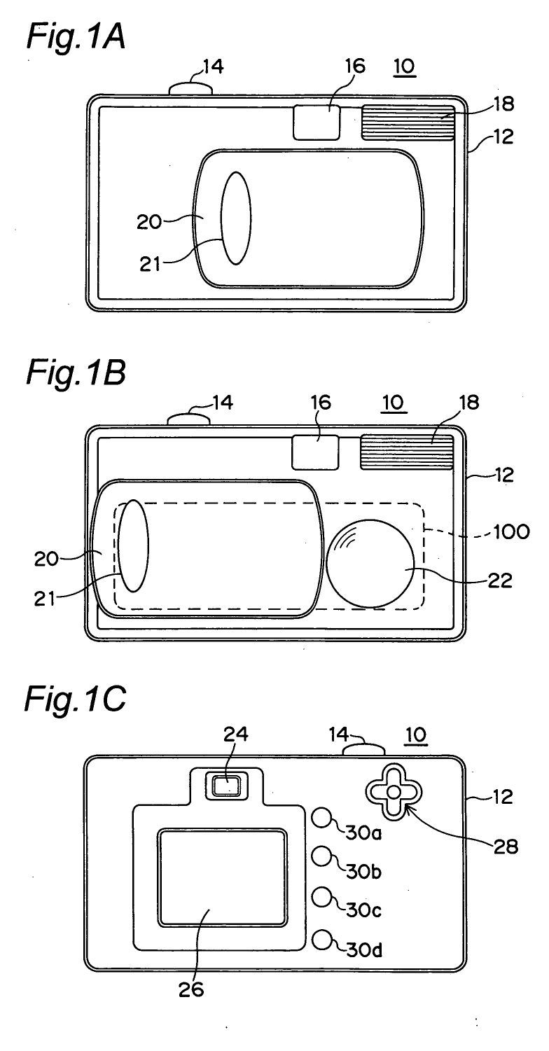

FIGS. 1A and 1B are front views showing a digital camera (hereinbelow simply referred to as a “camera”) 10 in a first embodiment of the present invention, and FIG. 1C is a rear view of the camera 10. The camera 10 has a camera body 12 constructed from a rectangle casing. A release button 14 is provided on the top surface of the camera body 12 for performing image capturing, while on the upper front surface of the camera body 12, there are provided an object-side optical viewfinder 16 and a flash 18 constructed from, for example, a xenon tube, a white LED and the like for illuminating an object during image capturing.

Provided on an outer front surface of the camera body 12 is an almost rectangular-shaped outer slide barrier 20 for covering and protecting the aperture section of a taking lens 22 included in a bending optical system 100. The outer slide barrier 20 is provided with a recess section 21 in aid of users to hook their fingers. The outer slide barrier 20 is slidable in a lateral direction between a close position shown in FIG. 1A and an open position shown in FIG. 1B. Herein, the term “lateral direction” refers to a left-and-right direction when the camera body 12 is in a normal operating state (the state that the release button 14 is directed in an upward direction). When the outer slide barrier 20 is in the close position, the taking lens 22 disposed on the front surface of the camera body 12 is covered with the outer slide barrier 20, whereas when the outer slide barrier 20 is in the open position, the outer slide barrier 20 is retreated from the taking lens 22 so as to completely expose the taking lens 22.

In this embodiment, although the outer slide barrier 20 is slid in a lateral direction, the outer slide barrier 20 may be arranged to be slid in a direction orthogonal to the lateral direction (i.e., a vertical direction or an oblique direction).

Moreover, although the slide barrier that is slidable for covering the taking lens 22 at the close position is provided outside the camera body 12, it is acceptable to provide the slide barrier inside the camera body 12.

Further, the camera 10 is a type of the camera whose barrel section including the taking lens 22 does not protrude from the camera body 12 in an image capturing standby state and during image capturing. However, the camera 10 may be a type of the camera whose barrel section is extended so as to protrude from the camera body 12 in the image capturing standby state and during image capturing.

As shown in FIG. 1C, on the back surface of the camera body 12, there are provided an eyepiece-side optical viewfinder 24, a display section 26 constructed from, for example, liquid crystal, organic EL and plasma displays or the like for displaying obtained images, a cross key 28 composed of up, down, left and right ON-buttons and a central push-button, and various function setting buttons 30a, 30b, 30c and 30d such as menu buttons, delete buttons and monitor buttons.

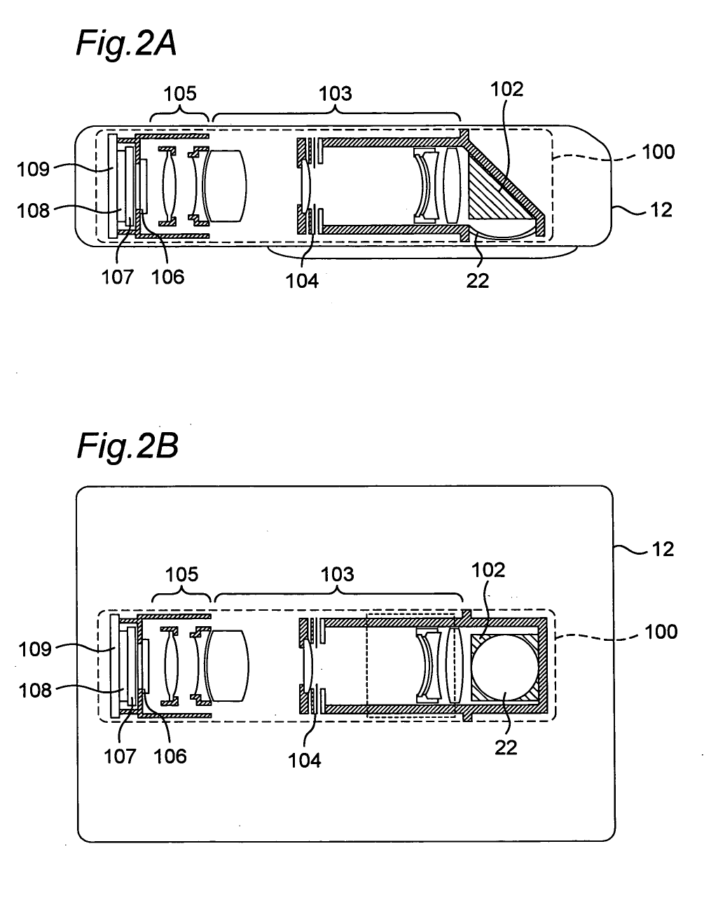

FIGS. 2A and 2B show details of the bending optical system 100 including the barrel section. The bending optical system 100 includes a taking lens 22 serving as an objective, a prism (or mirror) 102, a zoom lens group 103, a shutter and diaphragm 104, a focus lens group 105, a low-pass filter 106, an image pickup device (e.g., CCD or C-MOS) 107 for obtaining an image of an object, a cooling plate 108 and a circuit board 109. An object light ray, which is incident from the taking lens 22 and reflected by the prism 102, transmits through the lens groups 103 and 105, and forms an image on the image pickup device 107. The bending optical system 100 including the barrel section, in which the zoom lens group 103 moves to change a focal length, is not protruded from the camera body 12.

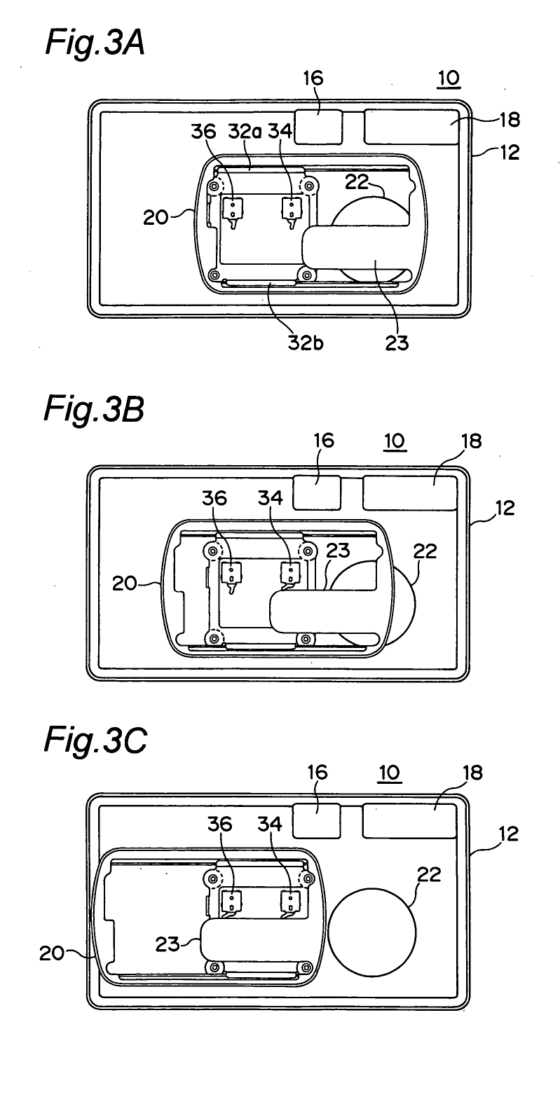

FIG. 3A shows an internal structure of the outer slide barrier 20. The outer slide barrier 20 is allowed sliding, while being guided by a pair of upper and lower guide members 32a and 32b. The outer slide barrier 20 is also integrally equipped with a detection protrusion 23 extending in a sliding direction. Further, along the sliding direction of the detection protrusion 23 of the outer slide barrier 20, a first detection switch (first detection member) 34 and a second detection switch (second detection member) 36 are fixed on the camera body 12 with a prescribed space interposed therebetween.

The first detection switch 34 is to detect that the outer slide barrier 20 is positioned in between the close position and the open position, more particularly, to detect that the outer slide barrier 20 is positioned in the vicinity of the close position or in the close position, whereas the second detection switch 36 is to detect that the outer slide barrier 20 is in the open position.

Therefore, the first detection switch 34, when in an OFF state as shown in FIG. 3A, can detect that the outer slide barrier 20 is in the close position. When the outer slide barrier 20 starts to open from the close position to the open position as shown in FIG. 3B, the first detection switch 34 turns to be in an ON state by engaging with the detection protrusion 23, which enables the first detection switch 34 to detect that the outer slide barrier 20 is positioned in the vicinity of the close position.

The second detection switch 36, when in an OFF state as shown in FIGS. 3A and 3B, can detect that the outer slide barrier 20 is not in the open position. When the outer slide barrier 20 reaches the open position as shown in FIG. 3C, the second detection switch 36 turns to be in an ON state by engaging with the detection protrusion 23, which enables the second detection switch 36 to detect that the outer slide barrier 20 is in the open position.

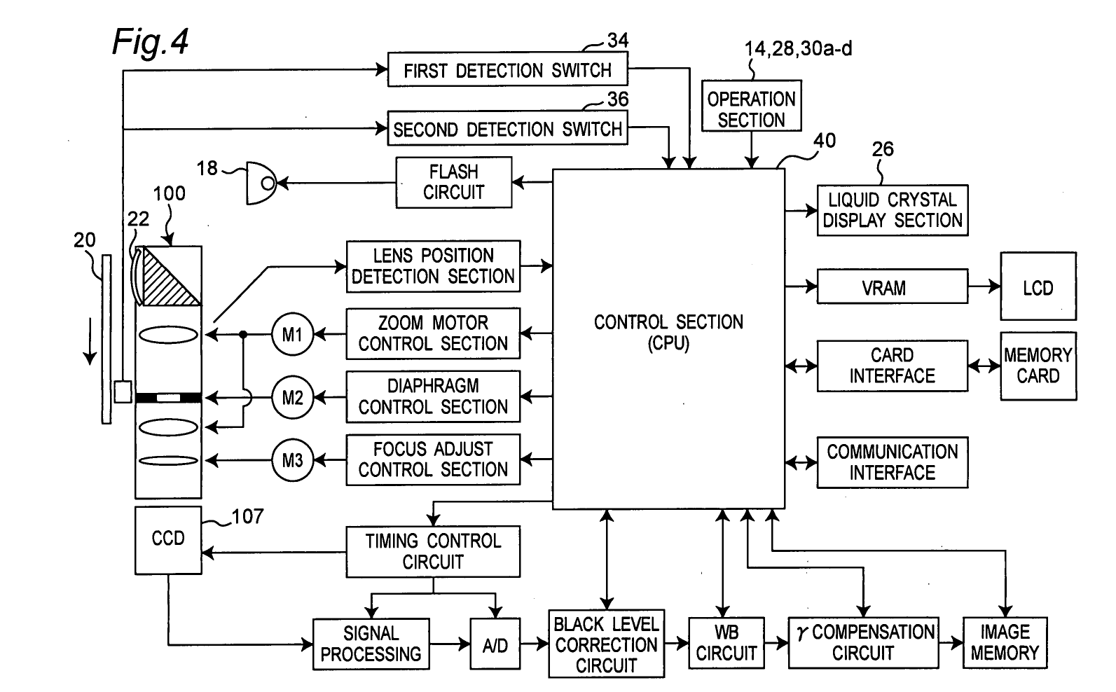

FIG. 4 is a block diagram showing the camera 10. The camera 10 includes a controller 40 constructed from a CPU. The controller 40 receives inputs of ON signals from the first detection switch 34 and the second detection switch 36. As described later, upon the input of an ON signal from the first detection switch 34, the camera 10 is powered on and the CPU 40 is activated in an image capturing mode. It is to be noted that even when the power is off, the CPU 40 is in a standby operation state in which the ON signal input from the first detection switch 34 is detectable, and therefore the input of the ON signal turns the power of the camera on, which activates the CPU 40 in the image capturing mode.

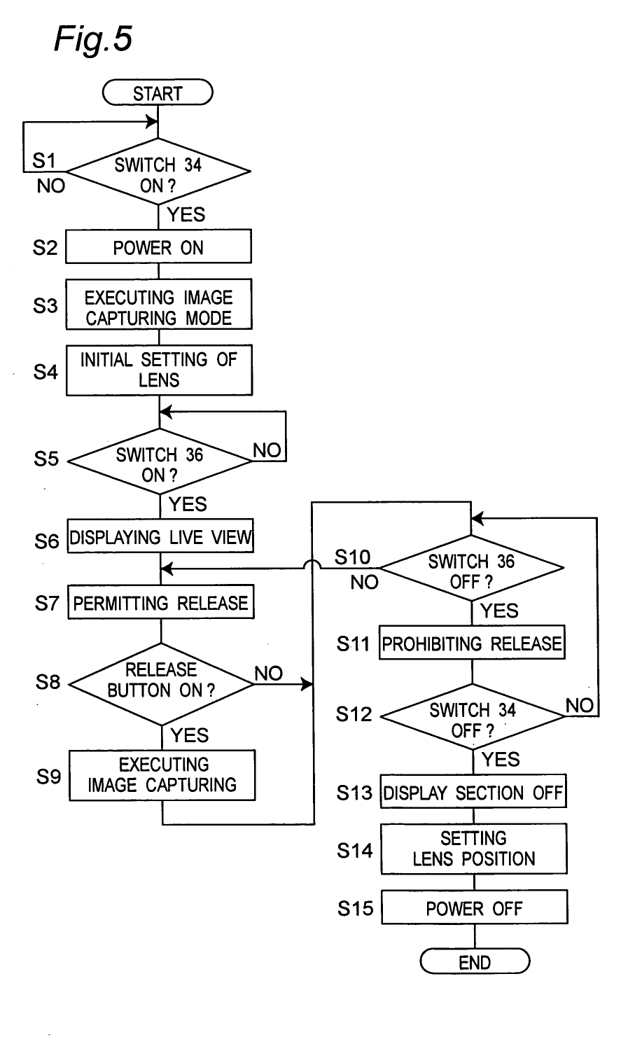

Following description discusses the operation and control of the above-constituted camera 10 with reference to FIG. 5 showing a control flow executed by the controller 40.

First, it is determined whether or not the first detection switch 34 is turned on (step S1), and the procedure is on standby till the first detection switch 34 is turned on (i.e., till a user starts opening operation of the outer slide barrier 20).

Once the opening operation of the outer slide barrier 20 is started by the user and the first detection switch 34 is turned on, the power is turned on and the camera 10 is activated (step S2). As a result, the CPU 40 is activated and the image capturing mode is executed (step S3), which starts activation of the image pickup device 107 and the display section 26 and charging of the flash 18, and at the same time, initial setting of each lens in the bending optical system 100 is performed (step S4).

Then, it is determined whether or not the second detection switch 36 is turned on (i.e., whether or not the outer slide barrier 20 reaches the open position) (step S5), and the procedure is on standby till the second detection switch 36 is turned on. Once the outer slide barrier 20 reaches the open position and the second detection switch 36 is turned on, live view display in the display section 26 is started (step S6), and release is permitted (step S7). Thereby the camera 10 in a state capable of capturing images.

Although in this control flow, the live view display is started when the outer slide barrier 20 reaches the open position, the live view display may be started when the image capturing mode is executed in the step S3.

Next, it is determined whether or not the release button 14 is turned on (step S8), and if the release button 14 is turned on, then image capturing is executed (step S9). Herein, the execution of image capturing includes exposure, image data processing, image data recording, and displaying after-view of a captured image in the display section 26. If the release button 14 is not turned on, then the procedure proceeds to the next step S10.

In the step S10, it is determined whether or not the second detection switch 36 is turned off (i.e., whether or not the outer slide barrier 20 is moved from the open position to the close position by the user starting the closing operation), and if the second detection switch 36 is turned off, then release is prohibited (step S1), whereas if the second detection switch 36 is not turned off, then the procedure returns to the step S7.

It is then determined whether or not the first detection switch 34 is turned off (i.e., whether or not the outer slide barrier 20 reaches the close position) (step S12). If the first detection switch 34 is not turned off, then the procedure returns to the step S10, whereas if the first detection switch 34 is turned off, then the display section 26 is switched off (step S13) and each lens in the bending optical system 100 is set at a specified position (step S14) before the power is turned off (step S15).

Thus, in the camera 10 in the present embodiment, when it is determined by the first detection switch 34 that the outer slide barrier 20 is positioned in between the close position and the open position and in the vicinity of the close position, the controller 40 immediately turns the power on to active the camera, making it possible to shorten the activation time compared to the case where the activation is started after the outer slide barrier 20 reaches the open position.

Moreover, it is possible to arrange so that the power is turned off only when the camera 10 is once activated and then the outer slide barrier 20 is detected to: be in the close position by the first detection switch 34. Eventually, the power is not turned off if the outer slide barrier 20 is fully moved to the open position and then moved for a short distance toward the close position side. Accordingly, in some conventional cameras with an outer slide barrier, even when the outer slide barrier is improperly moved for a short distance from the open position toward the close position side, the power is turned off and so re-activating operation is required. However, the camera in this embodiment is free from this inconvenience, making it possible to avoid complicated procedures for re-activating operation and time loss caused thereby.

Description is now given of a digital camera (hereinbelow simply referred to as a “camera”) 50 in a second embodiment. It is to be noted that members identical to those in the camera 10 in the first embodiment are designated by the identical reference numerals and detailed description thereof is omitted.

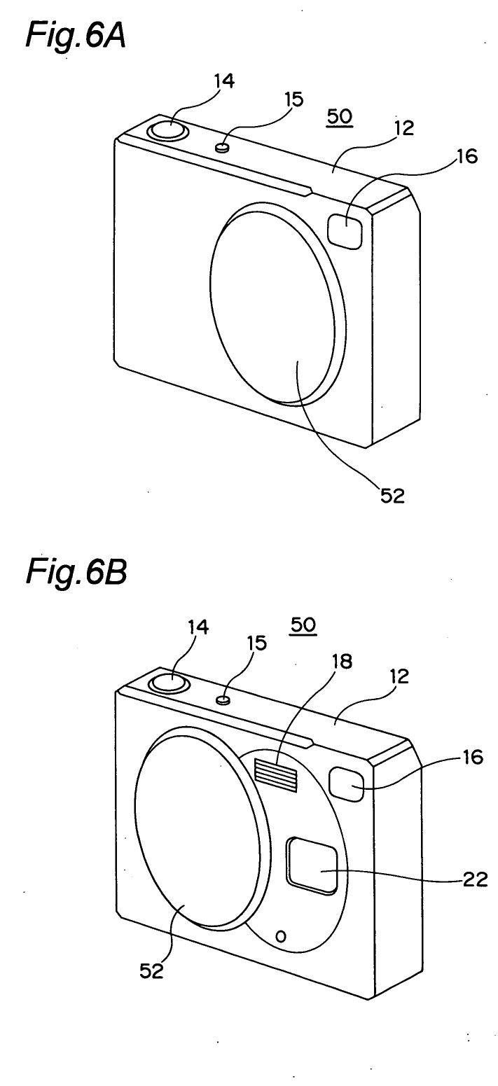

FIGS. 6A and 6B are perspective views showing the camera 50 viewed from the front surface side. The camera 50 has a camera body 12 constructed from a rectangle casing. A release button 14 and a power switch (instruction member) 15 are provided on the top surface of the camera body 12. When the power switch 15 is turned on, execution of a mode (e.g., reproducing mode) other than the image capturing mode is instructed.

Provided on an outer front surface of the camera body 50 is a disc-shaped outer slide barrier 52 serving as a protection member for covering and protecting the aperture section of a taking lens 22. The outer slide barrier 52 is allowed sliding in a lateral direction between a close position shown in FIG. 6A and an open position shown in FIG. 6B. When the outer slide barrier 52 is in the close position, the taking lens 22 and the flash 18 disposed on the front surface of the camera body 50 are covered with the outer slide barrier 52, whereas when the outer slide barrier 52 is in the open position retreated from the taking lens, the taking lens 22 and the flash 18 are completely exposed.

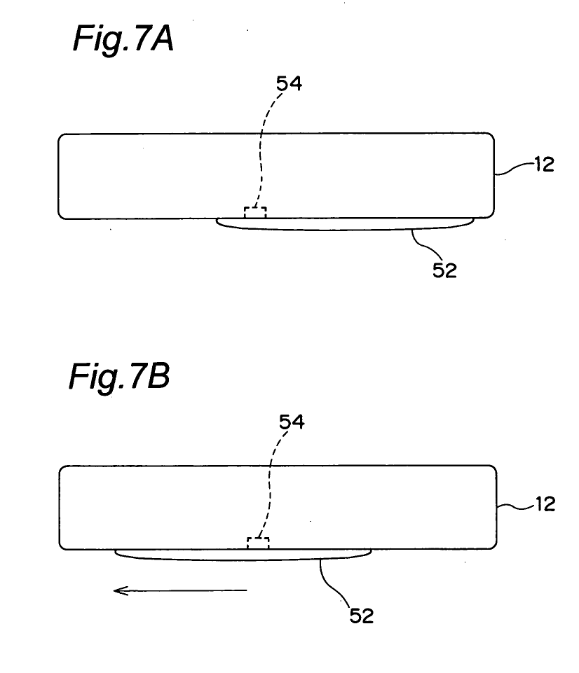

A detection switch 54 is disposed on the camera body 12 on the rear side of the outer slide barrier 52 as shown in FIGS. 7A to 7C. As a single switch, the detection switch 54 implements functions of both a detection member for detecting that the outer slide barrier 52 is in the close position shown in FIG. 7A and shown by a solid line in FIG. 7C and a detection member for detecting that the outer slide barrier 52 is in the open position shown in FIG. 7B and shown by a dotted line in FIG. 7C.

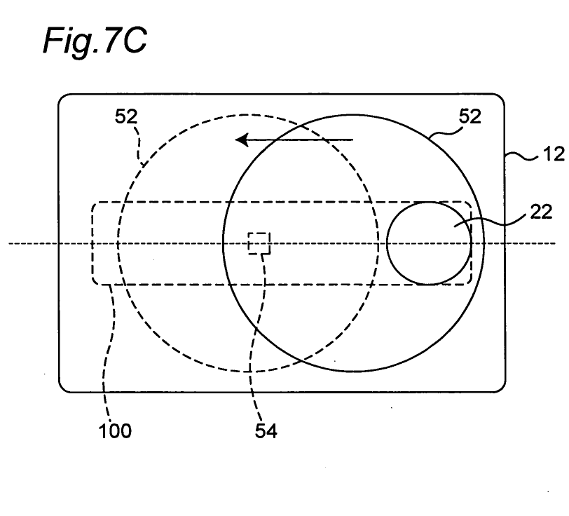

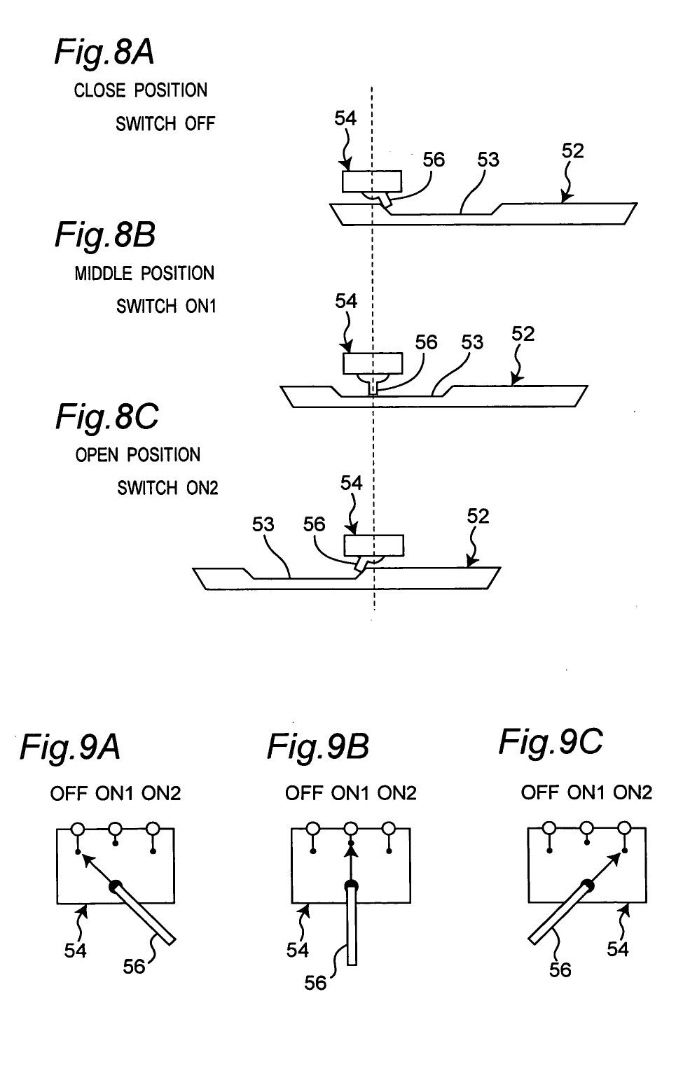

As shown in FIGS. 8A-8C, on the rear surface of the outer slide barrier 52, a recess section 53 is formed so as to face the detection switch 54. When the outer slide barrier 52 is in the close position, as shown in FIG. 8A and FIG. 9A, a detection piece 56 of the detection switch 54 engages with one side of the stepped edge portion of the recess section 53, by which the detection switch 54 is put in an OFF state.

When the outer slide barrier 52 starts sliding movement from the close position to the open position, as shown in FIG. 8B and FIG. 9B, engagement between the detection piece 56 of the detection switch 54 and one side of the stepped edge portion of the recess section 53 is released, by which the detection piece 56 is stationed at a neutral position. Therefore, when the outer slide barrier 52 is in a middle position between the close position and the open position, the detection switch 54 is put in a first ON state.

When the outer slide barrier 52 comes to the open position, as shown in FIG. 8C and FIG. 9C, the detection piece 56 of the detection switch 54 engages with the other side of the stepped edge portion of the recess section 53 on the outer slide barrier 52, by which the detection switch 54 is put in a second ON state.

Thus, a single detection switch 54 can detect that the outer slide barrier 52 is in the close position, the open position, or the middle position.

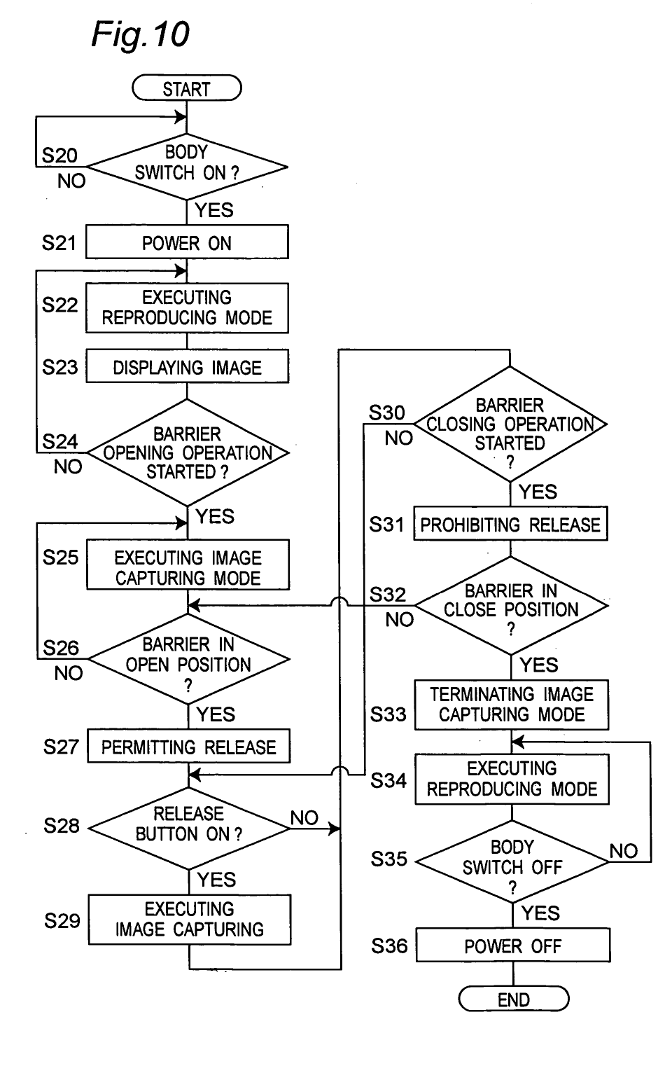

Following description discusses the operation and control of the above-constituted camera 50 with reference to FIG. 10 showing a control flow executed by the controller 40. It is to be noted that this control flow shows a control example in which the power switch 15 for a reproducing mode other than the image capturing mode is precedently turned off. A control flow in the case where the outer slide barrier 52 is operated before the power switch 15 is the same as that shown in FIG. 5.

First, it is determined whether or not the power switch 15 is turned on (step S20), and the procedure is on standby till the power switch 15 is turned on. Once the power switch 15 is turned on, the power of the camera 50 is switched on (step S21), the reproducing mode is executed (step S22), and a recorded image is displayed in a display section 26 (step S23).

Next, it is determined whether or not opening operation of the outer slide barrier 52 is started (step S24). This determination can be made by determining which states a detection switch 54 is in, an OFF state or a first ON state. If the outer slide barrier 52 is in the close position and the detection switch 54 is in the OFF state, then the opening operation of the outer slide barrier 52 is not yet started, and so the procedure returns to the step S22. If the opening operation of the outer slide barrier 52 is started and the detection switch 54 is turned to be in the first ON state, then the image capturing mode is executed (step S25), and so activation of the image pickup device 107, activation of the live view in the display section 26 and charging of the flash 18 are performed.

Then, it is determined whether or not the outer slide barrier 52 is in the open position (step S26). This determination can be made by determining whether or not the detection switch 54 is in a second ON state. If the detection switch 54 is in the first ON state and the outer slide barrier 52 is in a middle position, then the procedure returns to the step S25. If the outer slide barrier 52 comes to the open position and the detection switch 54 is turned to be in the second ON state, then release is permitted (step S27). Thereby the camera 50 in a state capable of capturing images.

It is then determined whether or not the release button 14 is turned on (step S28). If the release button 14 is turned on, then image capturing is executed (step S29), whereas if the release button 14 is not turned on, then the procedure proceeds to the next step S30.

Then, it is determined whether or not closing operation of the outer slide barrier 52 is started (step S30). This determination can be made by determining which states the detection switch 54 is in, a first ON state or a second ON state. If the outer slide barrier 52 is in the open position and the detection switch 54 is in the second ON state, then the closing operation of the outer slide barrier 52 is not yet started and so the procedure returns to the step S28. If the closing operation of the outer slide barrier 52 is started and the detection switch 54 is turned to be in the first ON state, then release is prohibited (step S31).

Next, it is determined whether or not the outer slide barrier 52 is in the close position (step S32). This determination can be made by determining which states the detection switch 54 is in, a first ON state or an OFF state. If the detection switch 54 stays in the first ON state and the outer slide barrier 52 is not in the close position, then the procedure returns to the step S26. If the outer slide barrier 52 comes to the close position and the detection switch 54 is turned to be in the OFF state, then the image capturing mode is terminated (step S33) and a reproducing mode for displaying an image in the display section 26 is executed (step S34).

Next, it is determined whether or not the power switch 15 is turned off (step S35). If the power switch 15 is not turned off, then the procedure returns to the step S34, whereas if the power switch 15 is turned off, then the power of the camera 50 is switched off (step S36).

Thus, the camera 50 in the present embodiment is capable of achieving the same function and effect as those of the camera 10 in the first embodiment. More specifically, in the camera 50 in this embodiment, the detection switch 54 can detect whether or not the outer slide barrier 52 is in the close position, and once the outer slide barrier 52 is detected not to be in the close position (i.e., the outer slide barrier 52 starts to move toward the open position), the controller 40 immediately stars activation of the image pickup device 107 and the like in the image capturing mode, allowing reduction of the activation time compared to the case in which activation of the image pickup device 107 and the like are started after the outer slide barrier 52 reaches the open position.

Moreover, it is possible to arrange so that the power is turned off only when the camera 50 is once activated and then the outer slide barrier 52 is detected to be in the close position by the detection switch 54. Eventually, the power is not turned off if the outer slide barrier 52 is fully moved to the open position and then moved for a short distance toward the close position side. Accordingly, in some conventional cameras with an outer slide barrier, even when the outer slide barrier is improperly moved for a short distance from the open position toward the close position side, the power is turned off and so re-activating operation is required. However, the camera 50 in this embodiment is free from this inconvenience, making it possible to avoid complicated procedures for re-activating operation and time loss caused thereby.

Further in the camera 50, a single detection switch 54 can detect that the outer slide barrier 52 is in the open position or the close position, allowing the cost reduced lower than that in the case of providing two detection switches.

It is to be noted that in the second embodiment, there are detected three states of the outer slide barrier, a state of the outer slide barrier 52 being in the close position, a middle position between the close position and the open position, and the open position. However, it is also possible to reduce the activation time and to avoid complicated procedures for re-activating operation and time loss caused thereby by providing another switch which is turned on when the outer slide barrier 52 is in the close position and controlling such that when this switch is turned off, the power is turned on and the camera 50 is activated, while when the switch is again turned on after being turned off, the power is turned off.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

1. A camera, comprising:
a slide barrier which is slidable along between a close position to cover a taking lens and an open position to retreat from the taking lens;
a first detection member which detects that the slide barrier is positioned in between the close position and the open position; and
a controller which activates the camera when it is detected by the first detection member that the slide barrier is positioned in between the close position and the open position.

2. The camera as defined in claim 1, wherein
the controller is constructed from a CPU, the camera further comprises an image pickup device for obtaining an image of an object and a display section for displaying an obtained image, and
the activating the camera includes activating, among the CPU, the image pickup device and the display section, at least the CPU.

3. The camera as defined in claim 1, further comprising an instruction member for instructing start of modes other than an image capturing mode, wherein
the image capturing mode is executed by the controller when execution of a mode other than the image capturing mode is instructed by the instruction member and then it is detected by the first detection member that the slide barrier is positioned in between the close position and the open position.

4. The camera as defined in claim 1, further comprising a barrel section including the taking lens, wherein the barrel section does not protrude from a body of the camera during image capturing.

5. The camera as defined in claim 1, wherein the first detection member detects that the slide barrier is in the vicinity of the close position.

6. The camera as defined in claim 5, further comprising a second detection member for detecting that the slide barrier is in the open position.

7. The camera as defined in claim 6, wherein the controller permits start of image capturing operation when the second detection member detects that the slide barrier is in the open position.

8. The camera as defined in claim 6, wherein the controller prohibits start of image capturing operation when the second detection member does not detect that the slide barrier is in the open position.

9. The camera as defined in claim 6, wherein the first detection member and the second detection member are constructed from one detection member.

10. The camera as defined in claim 6, wherein the controller turns a power of the camera off when the second detection member detects that the slide barrier is in the open position and then the first detection member detects that the slide barrier is in the vicinity of the close position.

11. A camera, comprising:
a slide barrier which is slidable along between a close position to cover a taking lens and an open position to retreat from the taking lens;
a detection member which detects that the slide barrier is in the close position; and
a controller which activates the camera when the detection member is in an inactive state.

12. The camera as defined in claim 11, wherein the controller is constructed from a CPU, the camera further comprises an image pickup device for obtaining an image of an object and a display section for displaying an obtained image, and
the activating the camera includes activating, among the CPU, the image pickup device and the display section, at least the CPU.

13. The camera as defined in claim 11, wherein the controller turns a power of the camera off when the detection member turns to be active after being in the inactive state.

14. The camera as defined in claim 11, further comprising a barrel section including the taking lens, wherein the barrel section does not protrude from a body of the camera during image capturing.

15. A method for activating a camera with a slide barrier which is slidable along between a close position to cover a taking lens and an open position to retreat from the taking lens, comprising the steps of:
detecting that the slide barrier is positioned in between the close position and the open position; and
activating the camera when it is detected that the slide barrier is positioned in between the close position and the open position.

16. The method as defined in claim 15, wherein said activating of the camera includes activating at least a CPU for controlling the camera among the CPU, an image pickup device for obtaining an image of an object and a display section for displaying an obtained image.

17. The method as defined in claim 15, wherein start of image capturing operation is permitted when it is detected that the slide barrier is in the open position.

18. The method as defined in claim 15, wherein start of image capturing operation is prohibited when it is not detected that the slide barrier is in the open position.

19. The method as defined in claim 17, wherein a power of the camera is turned off when it is detected that the slide barrier is in the open position and then it is detected that the slide barrier is in the vicinity of the close position.
